(19) United States
(12) Patent Application Publication
(10) Pub. No.: US 2012/0106767 A1
(43) Pub. Date: May 3, 2012

(54) SHAPED LOUDSPEAKER

(75) Inventor: Ambrose C. T. Thompson, Aylesbury (GB)

(73) Assignee: Martin Audio Limited, Buckinghamshire (GB)

(21) Appl. No.: 13/348,290

(22) Filed: Jan. 11, 2012

Related U.S. Application Data
(63) Continuation of application No. 12/443,076, filed on Mar. 26, 2009, now abandoned.

(51) Int. Cl. H04R 1/02

(52) U.S. Cl. 381/340

(57) ABSTRACT

A driver for a loudspeaker is mounted in an opening in an acoustic surface, for example a horn, and has a piston shaped to conform to the shape of the acoustic surface. This ensures that the presence of the driver does not disrupt the acoustic properties of the desired shape of the acoustic surface. Preferably the piston is made of closed cell foam and is attached directly to the coil holder of the driver unit.

### CROSS REFERENCE TO RELATED APPLICATION

This application is a continuation of application Ser. No. 12/443,076, filed Mar. 26, 2009 entitled “Shaped Loudspeaker,” which is a national phase application of PCT/GB2007/003702, filed Sep. 28, 2007 entitled “Shaped Loudspeaker,” both of which are incorporated herein by reference.

### BACKGROUND

The present invention relates to loudspeakers.

It is often desirable for loudspeaker systems, particularly those used for public address, to have the following features:

High acoustic power output. The acoustic power output is simply the “loudness” of the loudspeaker system.

A smooth and level frequency response. A smooth and level frequency response means that all frequencies of sound (across a particular range) are output at a similar level.

A defined constant directivity. The directivity relates to the levels of different frequencies that are present in different positions with respect to the loudspeaker. A loudspeaker with a defined directivity will deliver sound mainly to only a particular defined area. (A loudspeaker with a defined constant directivity is one which has constant directivity across a defined area.)

Low distortion. The sound output by the loudspeaker system should be free from objectionable amounts of all types of distortion.

The source of the sound from a loudspeaker system is one or more acoustic drive units. A typical drive unit is shown in FIG. 1A. The drive unit 500 comprises a motor system 501 and a coil holder 502. Attached to the coil holder 502 is a cone of paper 503. At the center of the cone 503 is a section of a dome shaped surface 504 of paper. Also attached to the motor system 501 is a frame 505 with a rim 506 by which the drive unit 500 can be mounted. A flexible seal 507 is provided between the rim of the frame and the cone, which forms an airtight seal. The coil holder vibrates in response to an electrical input signal. When the coil holder 502 vibrates this in turn causes the paper cone 503 (and also the dome shaped surface 504) to vibrate. These, acting as a piston, in turn vibrate the surrounding air, creating a sound. Thus the drive unit 500 converts the electrical input signal into sound. (The flexibility of the seal means that it does not impede the vibration of the cone.

In order to increase the acoustic power output of a drive unit a horn is often used, as shown in FIG. 1B. The drive unit 500′ is mounted at the base of the horn 510 so that the sound produced by the vibrating assembly passes through the horn. The function of the horn is to increases the efficiency with which the vibration of the cone 503 and dome shaped surface 504 is converted into vibration of the surrounding air and to control the directional behavior.

A single drive unit (even when used in conjunction with a horn) is often incapable of providing high enough acoustic power output across all the required frequencies. A solution to this is to have a loudspeaker system comprising two or more drive units, each of which operates in a different part of the frequency range of the loudspeaker (low-frequency and high-frequency, for example), and each having a high acoustic output in their particular range. This allows the loudspeaker system to have a high acoustic output over the combined ranges of the drive units.

The commonplace arrangement for multiple drive units is of course to mount them in openings in the same face of a box 103 as shown in FIG. 2A, where the loudspeaker system 100 has a low-frequency drive unit 101 and a high-frequency drive unit 102. However, a disadvantage of this system is that the directivity of the loudspeaker system is neither constant nor well-defined.

A loudspeaker system that attempts to fulfill the above criteria, and which has become increasingly popular, is the “line array” system, an example of which is shown in FIG. 2b. Line array system 200 comprises a number of nominally identical loudspeaker systems 201 arrayed vertically; each loudspeaker system 201 is known as an “element” of the line array system. The desirable properties of a single element are that horizontally the output is (i) symmetrical (ii) has defined constant directional properties and (iii) is smooth and level across the range of frequencies, while vertically the output becomes narrower, i.e. more directional as frequency increases. The line array system as a whole has a horizontal output similar to that of a single element (though with a greater overall acoustic power output as there are a number of elements), while the vertical directionality as result of the relative angles at which the elements are mounted in a particular installation.

An element for a line array system is described in “Methods to improve the horizontal pattern of a line array module in the midrange,” R Mores, N B Schroder and T Schwalbe, 120th Convention of the Audio Engineering Society, 2006. Two medium-sized conical drive units are placed to form a V-shaped horn through which higher frequency sound is directed. However, although the element generates a high acoustic power output and the two sections are closely spaced, there is considerable variation in horizontal directionality and smoothness of the frequency response, both due to the presence of resonant cavities within the horn.

Another element for a line array system is described in US 2002/0114482 A1. An example is shown in FIG. 2C, which is taken from that document. In this system a horn is divided into several channels, with different frequencies being directed through the different channels.

An element that uses a similar design technique is described in U.S. Pat No. 6,411,718 B1. An example is shown in FIG. 2D, which is taken from that document. A conical horn 10 has a high-frequency drive unit at its apex. Holes are provided along the sides of the horn, behind which are provided mid- and low-frequency drive units. Again, the resonant cavities formed by the holes in the sides of the horn have a detrimental effect on the horizontal directionality and frequency response smoothness of the element and create a high level of distortion. In addition the horn shapes are sub-optimal.

EP 0353092 discloses a horn loudspeaker having a loudspeaker diaphragm, which is a portion of one of the walls of the input area of the horn, that is to say, at the neck. This allows a large diaphragm to be used whilst still gaining the impedance matching effect of the horn.

U.S. Pat. No. 5,471,018 discloses a car radio or television audio system, in which a loudspeaker is mounted in an acoustic channel, the loudspeaker driver being mounted at the end of the channel. This aids reproduction of higher frequency signals.

EP 1278397 and GB 2364847 both disclose loudspeaker drive units having coaxially mounted high and mid frequency drive units. The high frequency drive unit is mounted on the axis while the mid range, which is in the form of a cone with a central aperture, is mounted surrounding it. The two drive units are driven by respective coaxially mounted coils of different radiuses, which extend into respective parts of a common magnet assembly. In fact, both these patents do not concern themselves with the novelty of coaxially mounted acoustic devices but details of the construction of the device (EP 1278397: the outer device's surround, GB 2364847: the arrangement of the magnet system). The choice in both cases of a thin walled cone for the outer device will in practice however place restrictions on its shape due to the amount of stiffness required for it to operate satisfactorily over its own frequency band with the result that, even if that was desired, it would not provide constant directivity for the driver device. In contrast, in embodiments of the present invention the use of a light and stiff solid material for the drive unit removes this limitation, thus allowing constant-directivity to be achieved.

GB 2250658 also shows a twin concentric loudspeaker with separately driven and mid range transducers, but the outer mid range transducer is in the form of a dome and has its coil coaxially mounted on its outer circumference. The aim of this device is to coaxially locate the two acoustic devices. The outer device does not aim to control the directivity of the inner device.

### SUMMARY

The present invention provides loudspeakers and methods of manufacturing those as defined in the appended claims.

### BRIEF DESCRIPTION OF THE DRAWINGS

There will now be described embodiments of the invention, with reference to the accompanying drawings of which:

FIG. 1A is a cross section of a known form of driver unit;

FIG. 1B is a cross section of a known form of horn loudspeaker;

FIG. 2A shows a known form of box loudspeaker having two drive units for different frequency ranges;

FIG. 2B shows a line array;

FIG. 2C shows another known speaker;

FIG. 2D shown a known horn speaker having drive units at the apex and in the walls of the horn;

FIG. 3 shows a loudspeaker in accordance with the invention;

FIG. 4 shows a driver unit in accordance with the invention;

FIG. 5 shows a the driver unit of FIG. 4 in place in a portion of horn;

FIG. 6A shows one method of sealing the driver unit of FIG. 4 to the acoustic surface;

FIG. 6B shows another method of sealing the driver unit of FIG. 4 to the acoustic surface;

FIGS. 7A and 7B show alternative constructions for the piston of the driver unit; and

FIG. 8 shows a further example of an acoustic surface.

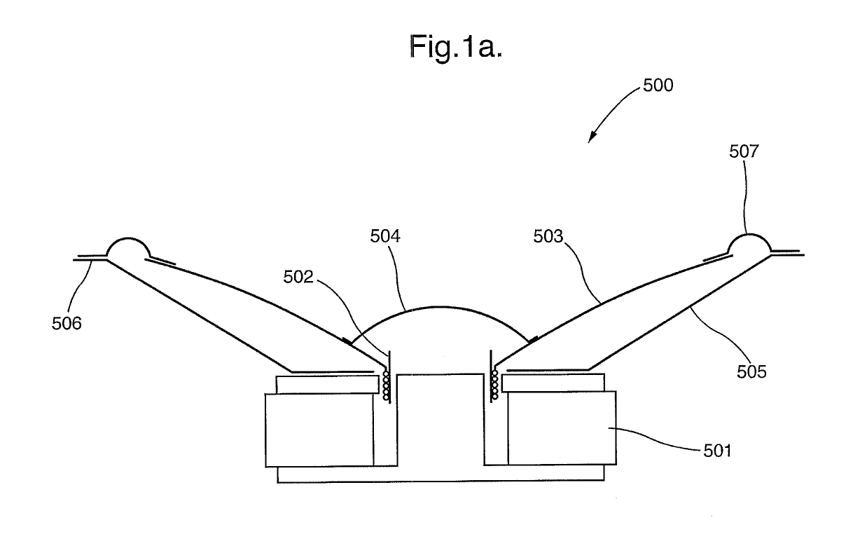

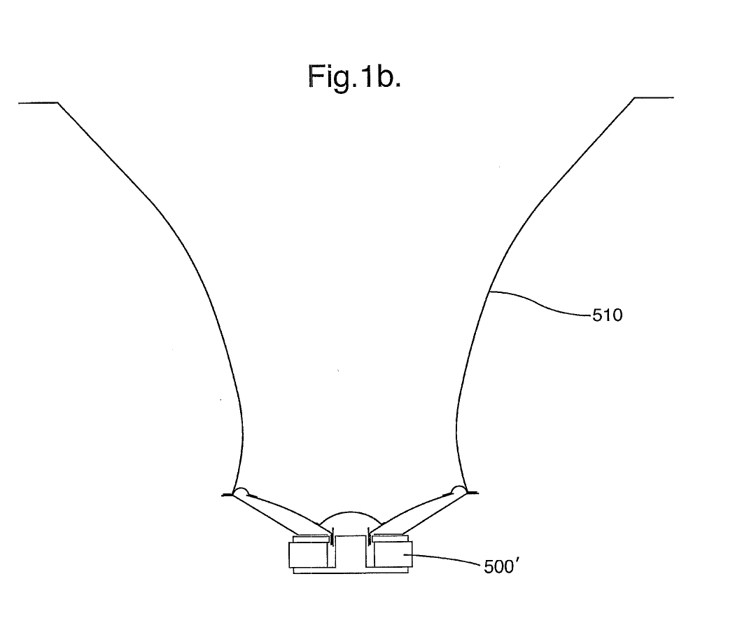

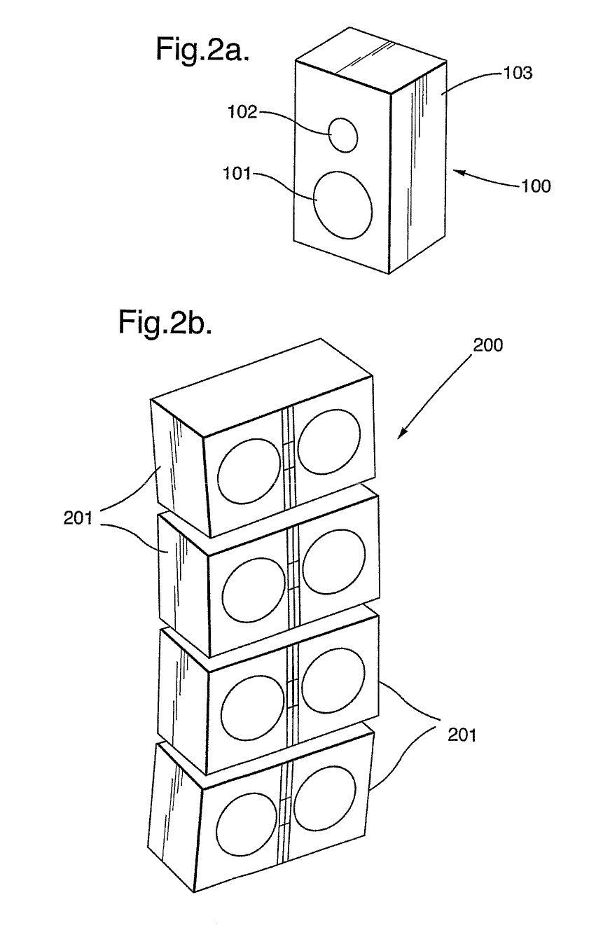

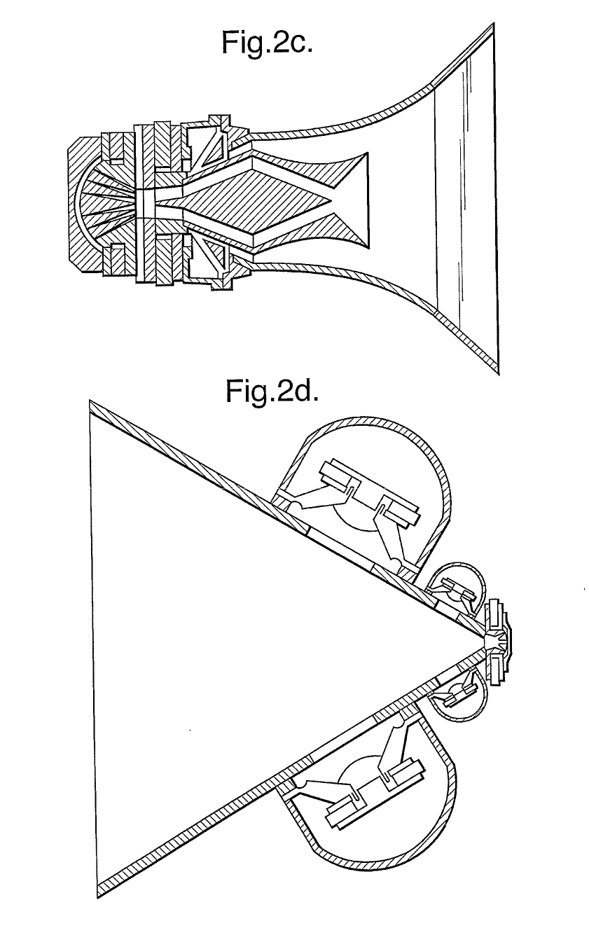

### DETAILED DESCRIPTION OF EXEMPLARY EMBODIMENTS

In the following description, like numbers refer to like elements.

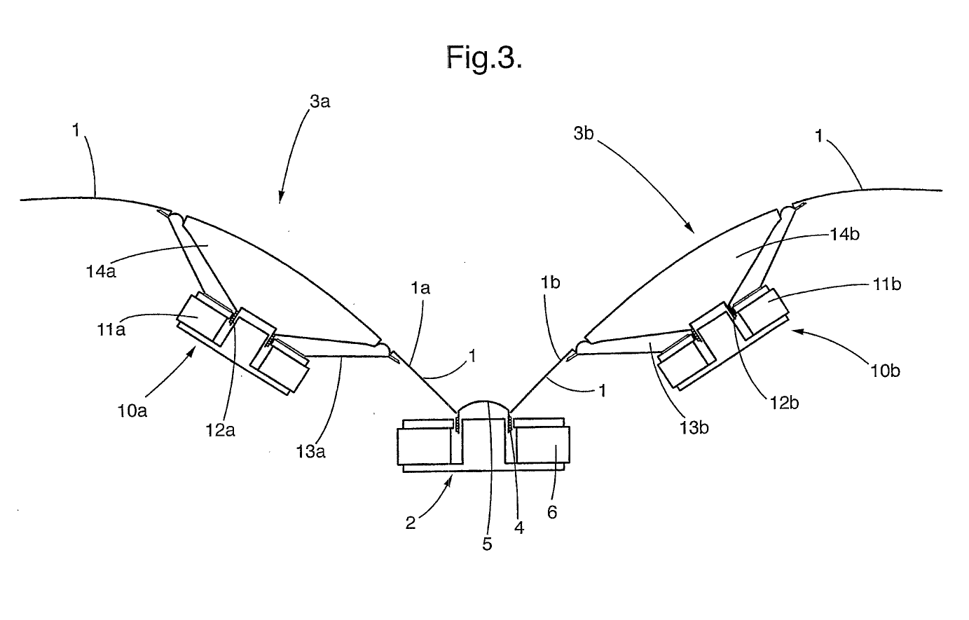

FIG. 3 shows a cross-section of a loudspeaker element according to the present invention. The element has a horn 1, with, at its base, a high-frequency drive unit 2 comprising a motor system 6, coil holder 4 and a dome shaped piston 5. The horn 1 has two openings 3a and 3b in the interior wall of the horn 1.

Behind the openings 3a and 3b there are mounted low-frequency drive units 10a and 10b respectively. The drive units 10a and 10b comprise, respectively, motor systems 11a and 11b, coil holders 12a and 12b and frames 13a and 13b, the latter being mounted to the edge of the openings 3a and 3b. The drive units also each comprise a lightweight stiff piston member 14a and 14b attached to the coil holder 12a and 12b of the drive unit.

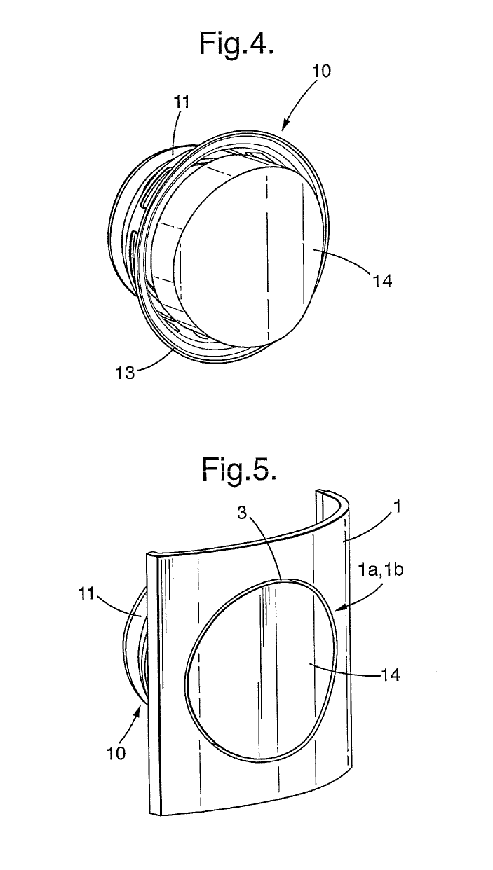

FIG. 4 is a perspective view of one of the drive units 10a, 10b, showing the motor system 11, frame 13 and the piston member 14. FIG. 5 is a perspective view of a section of the wall of the horn 1 with opening 3, and a drive unit 10 mounted behind the opening 3. As shown, the drive unit 10 is mounted so that surface of the piston member 14 that faces through the opening 3 is flush with the interior wall 1a or 1b of the horn 1, and the perimeter of the surface is such that only a small annular opening around the edge of the piston member 14 is present. Also, the surface of the piston member is so shaped that it conforms to the shape of the interior wall of the horn 1.

In use, the interior wall of the horn 1 performs as if it has no openings, as the surface of the piston member 14 facing through the opening 3 takes the place of the missing section of wall. The detrimental effects caused by the cavities in the prior art elements is therefore greatly reduced. The movement of the member 14 into and out of space defined by the horn, which is caused by the vibration of the coil holder, makes little difference to the effect of the horn 1 on the acoustic output of the high-frequency drive unit 2. This lack of cavities also means that the horn also performs well for the sound output by the drive units 5 themselves, which the cavities of previously known designs also degraded.

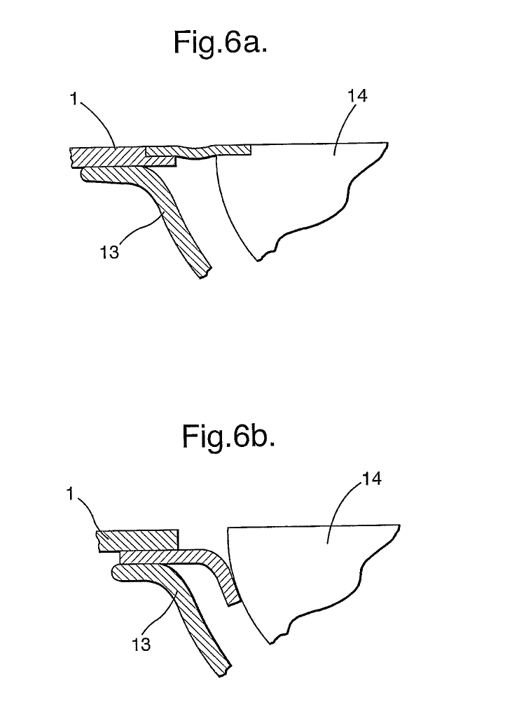

Although not shown in FIG. 5 for simplicity of illustration, the drive unit also comprises a flexible seal between the perimeters of the piston member 14 and the opening 3. Preferably this is attached to the piston member and the edge of the opening as shown in FIG. 6A but can also be attached between the piston member and the frame as shown in FIG. 6B.

The piston member 14 should be light enough that the drive unit 10 provides a similar acoustic power output as a standard drive unit alone. The piston member 14 should also be rigid over the operating frequencies of the drive unit, and preferably 1 to 2 octaves above. Being rigid over that range of frequencies means that it vibrates in phase with the coil holder and reproduces the desired sound properly. If sound from another source, for example drive unit 2, the piston member 14 should provide an acoustic surface similar to the desired rigidity of the acoustic surface 1 at the frequencies of those other sounds. Generally the acoustic surface will be simply rigid meaning that sound substantially reflects from it and if that is the case the piston should be simply (or adequately) rigid over the frequencies of the sounds from the other source.

A rigid closed-cell foam solid has been found to work well, for example, a polymethacrylimide foam, for example, that known as Rohacell™. Another possible material for a piston member are layered honeycomb structures made, for example from mylar, metal foil or craft paper. Lightweight composites would also be suitable.

A preferred example uses Rohacell 31IG which has a density of 32 kg m³ and an elastic modulus of 36 MPa.

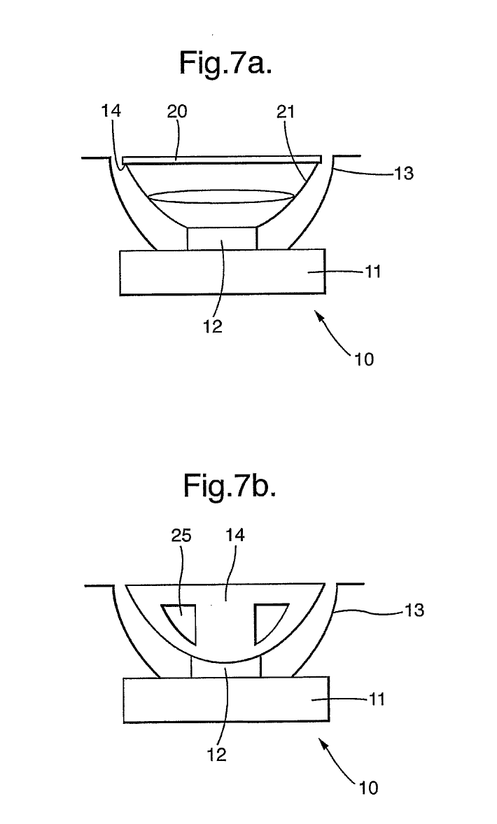

Alternatively, the piston member 14 could for example comprise a solid surface 20 mounted on a frame 21, as shown in FIG. 7a, or be a solid piece with cavities 25 in order to reduce its weight, as shown in FIG. 7b.

In the preferred example, the pair of drive units 10a and 10b are laterally spaced. This causes the output to be more directional. In general, the greater the spacing, the greater the directivity. Also, the directivity increases with frequency. This can mean that at the upper end of the range of the drive units 10a and 10b their combined output is too narrow for use in an auditorium. This reduces the maximum sensible frequency for the crossover that splits the signal between the mid range and the high frequency drive units. So the crossover is arranged to pass to the high frequency drive unit frequencies that would be too directional if emitted by the mid range drive units. Thus, there is a compromise in this design between the size of the mid range drive units 10a and 10b and the crossover frequency. Having big drive units 10a, 10b would provide more acoustic output, but would reduce the crossover frequency because frequencies at the upper end of their range would be too directional. In the example shown, the crossover frequency is 2 kHz.

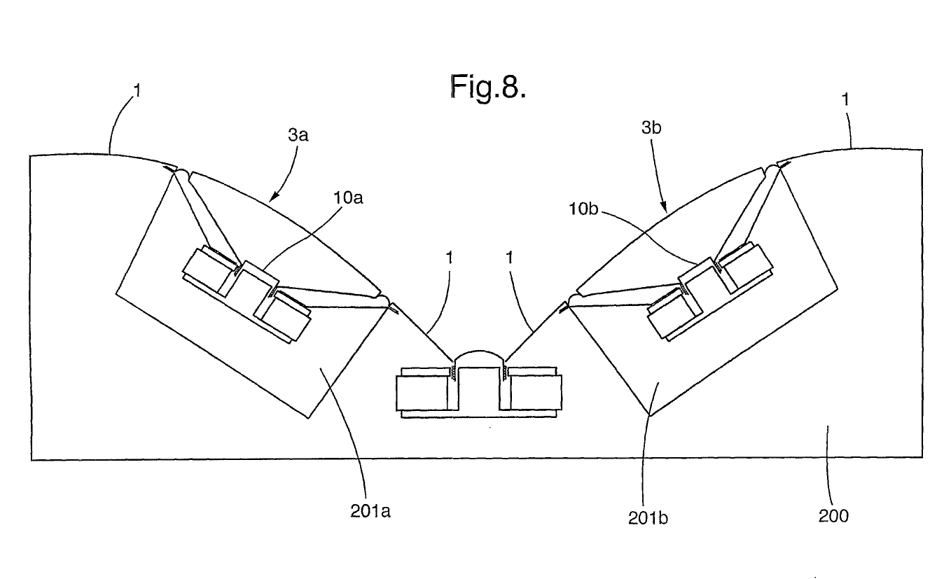

In the examples so far described the acoustic surface has been provided by a thin sheet of material. The invention is equally applied to the situation shown in FIG. 8, where the acoustic surface 1 (in the example of FIG. 8 a horn) is provided by the inner surface of a solid 200, and the openings 3a and 3b lead to cavities 201a and 201b in the solid 200, with the drive units 10a and 10b are being mounted within those cavities.

When designing a loudspeaker element according to the present invention, a method is as follows. First, the desired acoustic surface, in this example a horn, is obtained. This may be by calculation, iterative experiment, experience or otherwise. Openings in the horn for the drive units are then planned. The shapes of the piston members 14 are then determined to complete the original selected shape of the acoustic surface in the regions of the openings. Preferably this should be the same shape, which is straightforward to achieve—in the case of closed-cell foam it is easily formed into any shape.

Although not ideal in some applications it may be sufficient for the surface of the piston to be an approximation to the desired shape. For example, a curved surface could be approximated by a faceted surface (i.e. a surface having one or more facets). Once such surface for the piston has been so determined the piston of the drive unit is made to that shape. A possible method of making a drive unit is simply to take a standard drive unit and remove the paper cone, dome shaped surface and seal, and mount the piston member directly onto the coil holder of the drive unit.

The foregoing description is of examples embodying, at least in part, certain teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments.

What is claimed is:

1. A loudspeaker comprising
a horn having an acoustic surface with which sound interacts, and
a first drive unit comprising an active surface that vibrates to produce sound, the first drive unit being mounted in the side of the horn,
the first drive unit being so mounted, and the active surface being so shaped, that the active surface is located in and conforms to the shape of the acoustic surface of the horn,
the loudspeaker comprising a second drive unit located so that the sound it produces
interacts with the acoustic surface including with the portion thereof provided by the active surface of the first drive unit.

2. A loudspeaker as claimed in claim 1 wherein the active surface is convex along at least one axis.

3. A loudspeaker as claimed in claim 1 wherein the active surface has one or more facets.

4. A loudspeaker as claimed in claim 1 wherein the second drive unit is located at the apex of the horn.

5. A loudspeaker as claimed in claim 1 comprising another first drive unit, comprising an active surface that vibrates to produce a sound, the another first drive unit being mounted symmetrically disposed from the first-mentioned first drive unit in the horn in an opposite side thereof, the first-mentioned first-drive unit also being so mounted, and its active surface being so shaped, that its active surface is located in and conforms to the shape of the acoustic surface of the horn, the sound produced by the second drive unit also interacting with the portion of the acoustic surface provided by the active surface of the another first drive unit.

6. A loudspeaker as claimed in claim 1 wherein the first drive unit is such that it produces relatively low frequency sound and the second drive unit is such that it produces relatively high frequency sound.

7. A loudspeaker as claimed in claim 1 wherein the first drive unit is operative over a particular range of audio frequencies and the active surface of the first drive unit is substantially rigid when vibrated at those frequencies.

8. A loudspeaker as claimed in claim 1 wherein the second drive unit is operative over a particular range of audio frequencies and the active surface of the first drive unit is substantially rigid over those frequencies.

9. A loudspeaker as claimed in claim 1 wherein the first drive unit comprises a piston that vibrates, and that comprises the active surface.

10. A loudspeaker as claimed in claim 9 wherein the piston comprises at least a portion that is formed of closed-cell foam, a honeycomb structure or a composite material, and that provides the active surface.

11. A loudspeaker as claimed in claim 10 that comprises a coil holder and wherein the said portion having the active surface is mounted directly on the coil holder.

12. A loudspeaker as claimed in claim 10 wherein the drive unit comprises a cone mounted to vibrate and the said portion having the active surface is mounted on the cone.

13. A loudspeaker as claimed in claim 9 wherein the acoustic surface of the horn is provided with an opening, and the piston is shaped to substantially fill the opening.

14. A loudspeaker as claimed in claim 1 that comprises a line array element.
